(19) United States
(12) Patent Application Publication
(10) Pub. No.: US 2019/0186626 A1
(43) Pub. Date: Jun. 20, 2019

(54) SHIFT DEVICE

(71) Applicant: KABUSHIKI KAISHA TOKAI-RIKA-DENKI-SEISAKUSHO, Aichi (JP)

(72) Inventors: Hiroki ONO, Aichi (JP); Kengo KITAJIMA, Aichi (JP); Keisuke KAMEYAMA, Aichi (JP)

(21) Appl. No.: 16/326,564

(22) PCT Filed: Aug. 28, 2017
(86) PCT No.: PCT/JP2017/030760

§ 371 Date: Feb. 19, 2019

(30) Foreign Application Priority Data
Aug. 26, 2016 (JP) 2016-165752

(51) Int. Cl. F16H 59/02; F16H 59/04; F16H 59/10

(52) U.S. Cl. CPC F16H 59/0204; F16H 59/105; F16H 59/044

(57) ABSTRACT

When a lever of a shift device is swung along an automatic path, a link is swung as a unit with the lever. A swing position of the link is thereby detected in order to detect a shift position of the lever. When the lever is swung along a manual path, a swing position of the lever is detected in order to detect a shift position of the lever. Note that when the lever is swung along the manual path, the swing position of the link is maintained at a position corresponding to that when the lever is at a D position on the automatic path. This thereby enables the shift position of the lever on the manual path to be detected in a state in which detection of the lever being at the D position is maintained.

### TECHNICAL FIELD

The present invention relates to a shift device in which a shift body is moved to change a shift position of the shift body.

### BACKGROUND ART

In a shift lever device disclosed in Japanese Patent Application Laid-Open (JP-A) No. 2000-108707, a shift lever is moved along a first movement path to change a shift position of the shift lever between an R position and an N position. The shift position of the shift lever on the first movement path is detected by movement of a first link that is moved by movement of the shift lever along the first movement path.

The shift lever is also moved along a second movement path to change a shift position of the shift lever between an S position, a + position, and a − position. The shift position of the shift lever on the second movement path is detected by movement of a second link that is moved by movement of the shift lever along the second movement path.

In such a shift lever device, the shift position of the shift lever on the second movement path sometimes needs to be detected in a state in which detection of a predetermined shift position of the shift lever on the first movement path is maintained.

### SUMMARY OF INVENTION

### Technical Problem

In consideration of the above circumstances, an object of the present invention is to obtain a shift device capable of detecting a shift position of a shift body on a second movement path in a state in which detection of a predetermined shift position of the shift body on a first movement path is maintained.

### Solution to Problem

A shift device of a first aspect of the present invention includes a shift body, a first detector, and a second detector. The shift body is moved along a first movement path and along a second movement path to change a shift position. The first detector is provided with a first movement section moved by movement of the shift body along the first movement path. A shift position of the shift body on the first movement path is detected using movement of the first movement section, and a position of the first movement section is maintained at a position corresponding to that when the shift body is at a predetermined shift position on the first movement path when the shift body is moved along the second movement path. The second detector is provided with a second movement section moved by movement of the shift body along the second movement path, and a shift position of the shift body on the second movement path is detected using movement of the second movement section.

A shift device of a second aspect of the present invention is the shift device of the first aspect of the present invention, wherein the first movement section is capable of swinging, and the shift device includes an urging member that urges the first movement section from both swing direction sides toward a swing position corresponding to that when the shift body is at the predetermined shift position.

A shift device of a third aspect of the present invention is the shift device of the first aspect or the second aspect of the present invention, further including a first configuration section that configures the first detector, a second configuration section that configures the second detector, and an installation member on which the first configuration section and the second configuration section are installed.

A shift device of a fourth aspect of the present invention is the shift device of any one of the first aspect to the third aspect of the present invention, further including a configuration section that configures at least one of the first detector or the second detector, and that is disposed laterally to the shift body.

A shift device of a fifth aspect of the present invention is the shift device of any one of the first aspect to the fourth aspect of the present invention, further including a second configuration section that configures the second detector, the second movement section approaching the second configuration section as the shift body moves from the first movement path to the second movement path, and the second movement section moving parallel to the second configuration section as the shift body moves along the second movement path.

A shift device of a sixth aspect of the present invention is the shift device of any one of the first aspect to the fifth aspect of the present invention, further including a placement section, a movement portion, and a maintaining portion. The placement section is provided at one of the shift body or the first movement section. The movement portion is provided at another of the shift body or the first movement section, the placement section being disposed in the movement portion when the shift body is disposed on the first movement path, such that the first movement section is moved by movement of the shift body. The maintaining portion is provided at the other of the shift body or the first movement section, the placement section being disposed in the maintaining portion when the shift body is disposed on the second movement path, such that a position of the first movement section is maintained even if the shift body is moved.

A shift device of a seventh aspect of the present invention is the shift device of any one of the first aspect to the sixth aspect of the present invention, further including an exposing section that is provided at the first movement section, and that exposes the second movement section on an opposite side of the first movement section from the shift body.

A shift device of an eighth aspect of the present invention is the shift device of any one of the first aspect to the seventh aspect of the present invention, wherein the shift body and the first movement section are capable of swinging on a same axis.

A shift device of a ninth aspect of the present invention is the shift device of any one of the first aspect to the seventh aspect of the present invention, wherein a swing axis of the shift body and a swing axis of the first movement section are configured so as to be different from each other.

A shift device of a tenth aspect of the present invention is the shift device of any one of the first aspect to the ninth aspect of the present invention, further including an assembly member to which the shift body, the first detector, and the second detector are assembled.

### Advantageous Effects of Invention

In the shift device of the first aspect of the present invention, the shift body is moved along the first movement path and the second movement path to change the shift position of the shift body. When the shift body is moved along the first movement path, the first movement section of the first detector is moved. The first detector thereby detects the shift position of the shift body on the first movement path. Moreover, when the shift body is moved along the second movement path, the second movement section of the second detector is moved. The second detector thereby detects the shift position of the shift body on the second movement path.

Note that when the shift body is moved along the second movement path, the position of the first movement section is maintained at a position corresponding to that when the shift body is at the predetermined shift position on the first movement path. Thus, the second detector is able to detect the shift position of the shift body on the second movement path in a state in which detection by the first detector that the shift body is at the predetermined shift position on the first movement path is maintained.

In the shift device of the second aspect of the present invention, the first movement section is capable of swinging.

Note that the urging member urges the first movement section from both swing direction sides toward the swing position corresponding to that when the shift body is at the predetermined shift position. This enables the first movement section to be urged from both swing direction sides toward the swing position corresponding to that when the shift body is at the predetermined shift position with a simple configuration.

In the shift device of the third aspect of the present invention, the first configuration section configures the first detector, and the second configuration section configures the second detector. The first configuration section and the second configuration section are both installed on the installation member. This enables the number of components to be reduced.

In the shift device of the fourth aspect of the present invention, the configuration section configures at least one of the first detector or the second detector, and the configuration section is disposed laterally to the shift body. This enables liquid to be easily suppressed from collecting at the configuration section.

In the shift device of the fifth aspect of the present invention, the second configuration section configures the second detector. The second movement section approaches the second configuration section as the shift body moves from the first movement path to the second movement path, and the second movement section moves parallel to the second configuration section as the shift body moves along the second movement path. This enables high quality detection of the shift position of the shift body on the second movement path by the second detector.

In the shift device of the sixth aspect of the present invention, the placement section is provided at one of the shift body or the first movement section, and the movement portion and the maintaining portion are provided at the other of the shift body or the first movement section. The placement section is disposed in the movement portion when the shift body is disposed on the first movement path, such that the first movement section is moved by movement of the shift body, and the placement section is disposed in the maintaining portion when the shift body is disposed on the second movement path, such that the position of the first movement section is maintained even if the shift body is moved.

Providing the movement portion and the maintaining portion to the other of the shift body or the first movement section enables the number of components to be reduced.

In the shift device of the seventh aspect of the present invention, the exposing section is provided at the first movement section. The exposing section exposes the second movement section on the opposite side of the first movement section from the shift body. This enables the first movement section and the second movement section to be disposed closer to each other, enabling a reduction in size.

In the shift device of the eighth aspect of the present invention, the shift body and the first movement section are capable of swinging on the same axis. This enables the accuracy of the swing position of the first movement section by swinging of the shift body to be improved.

In the shift device of the ninth aspect of the present invention, the swing axis of the shift body and the swing axis of the first movement section are configured so as to be different from each other. This enables the swing amount of the shift body and the swing amount of the first movement section to be made to differ from each other.

In the shift device of the tenth aspect of the present invention, the shift body, the first detector, and the second detector are assembled to the assembly member. This enables the ease of assembly of the shift body, the first detector, and the second detector to be improved.

### BRIEF DESCRIPTION OF DRAWINGS

FIG. 1A is a perspective view illustrating a lever of a shift device according to an exemplary embodiment of the present invention when disposed at an R position, as viewed from the oblique rear-left.

FIG. 1B is a perspective view illustrating the lever of the shift device according to the exemplary embodiment of the present invention when disposed at an N position, as viewed from the oblique rear-left.

FIG. 1C is a perspective view illustrating the lever of the shift device according to the exemplary embodiment of the present invention when disposed at a D position, as viewed from the oblique rear-left.

FIG. 2A is a perspective view illustrating the lever of the shift device according to the exemplary embodiment of the present invention when disposed at an M position, as viewed from the oblique rear-left.

FIG. 2B is a perspective view illustrating the lever of the shift device according to the exemplary embodiment of the present invention when disposed at a + position, as viewed from the oblique rear-left.

FIG. 2C is a perspective view illustrating the lever of the shift device according to the exemplary embodiment of the present invention when disposed at a − position, as viewed from the oblique rear-left.

FIG. 3A is a perspective view illustrating the lever of the shift device according to the exemplary embodiment of the present invention, as viewed from the oblique rear-left.

FIG. 3B is a face-on view illustrating a link of the shift device according to the exemplary embodiment of the present invention, as viewed from the left.

### DESCRIPTION OF EMBODIMENTS

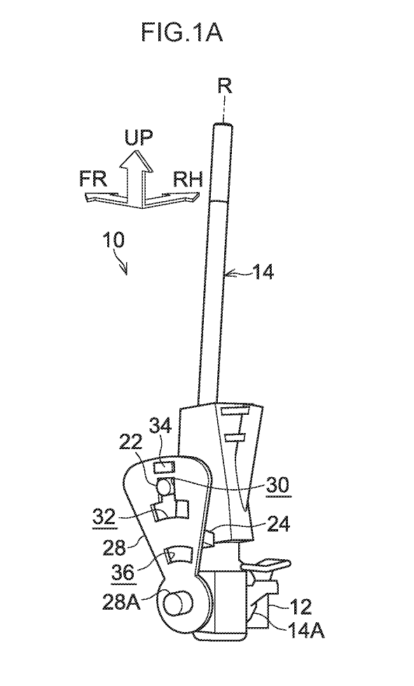

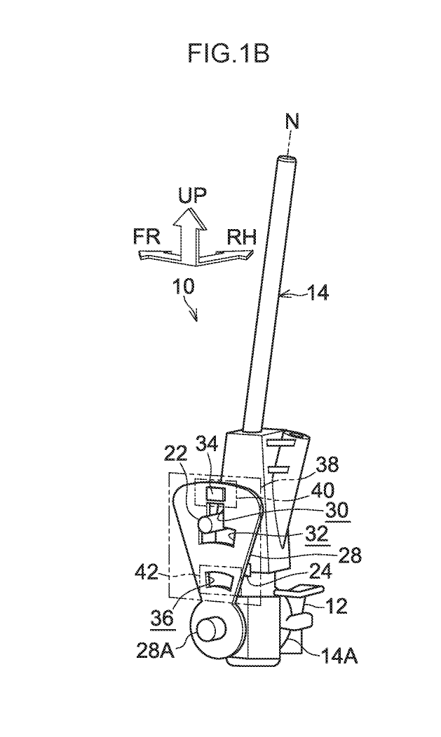

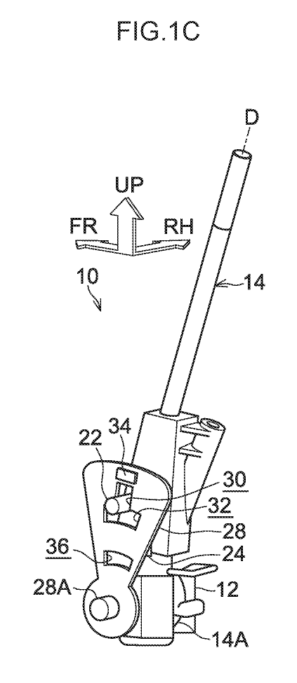

FIG. 1B is a perspective view of a shift device 10 (shifter) according to an exemplary embodiment of the present invention, as viewed from the oblique rear-left. Note that in the drawings, the arrow FR indicates the front of the shift device 10, the arrow RH indicates the right side of the shift device 10, and the arrow UP indicates the upper side of the shift device 10.

The shift device 10 according to the present exemplary embodiment is applied to a vehicle (automobile). The shift device 10 is what is referred to as a floor-mounted type, and is installed to a floor section (floor) of a vehicle cabin. The front, right, and upper sides of the shift device 10 respectively correspond to the front, right, and upper sides of the vehicle.

A substantially rectangular box shaped plate (housing, not illustrated in the drawings), serving as an assembly body, is provided to the shift device 10. The plate is fixed to the floor section of the vehicle cabin so as to install the shift device 10 to the floor section of the vehicle cabin. A first plate (not illustrated in the drawings), serving as an assembly member, is provided on the left side of the plate, and a second plate (not illustrated in the drawings) is provided on the right side of the plate. The plate is configured by assembling the first plate and the second plate together. An operation hole (not illustrated in the drawings) with a predetermined shape is formed passing through an upper wall of the plate.

As illustrated in FIG. 1B, a bottomed, substantially circular tube shaped support tube 12, serving as a support section, is assembled to a lower end of the inside of the first plate configuring the plate. The inside of the support tube 12 is open toward the upper side.

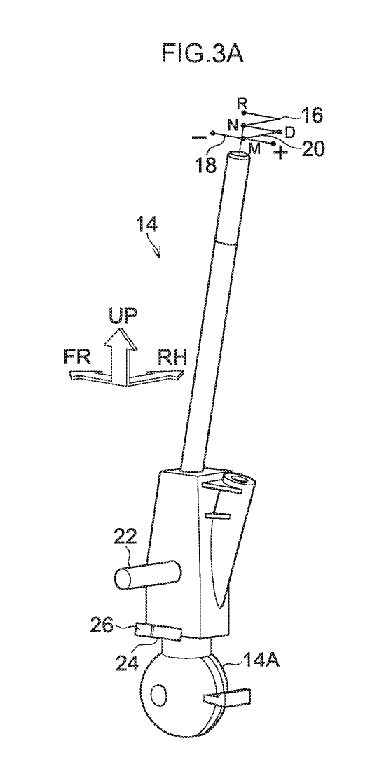

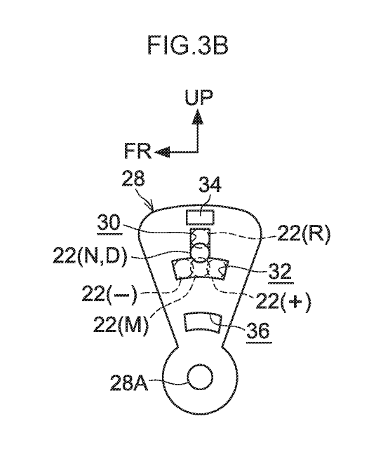

A substantially rod shaped lever 14 (see FIG. 3A), serving as a shift body, is provided inside the plate. A substantially spherical shaped ball shaft 14A, serving as a swing axis, is integrally provided at a lower end portion of the lever 14. The ball shaft 14A is rotatably supported inside the support tube 12. The lever 14 is capable of swinging (moving) about the ball shaft 14A in both the front-rear direction (shift direction) and the left-right direction (select direction).

The lever 14 passes through the operation hole in the upper wall of the plate and extends toward the upper side of the plate. An upper end portion of the lever 14 is capable of being swing-operated by an occupant (driver) of the vehicle. The lever 14 is capable of swinging so as to follow the operation hole. The lever 14 is capable of swinging along an automatic path 16 serving as a first movement path on the right side, a manual path 18 (sequential path) serving as a second movement path on the left side, and a communication path 20 located between the automatic path 16 and the manual path 18.

The lever 14 is disposed at an N position (neutral position), serving as a shift position on the automatic path 16. When the lever 14 is swung from the N position toward the right side and then swung toward the front side along the automatic path 16, the lever 14 is disposed at an R position (reverse position, backward drive position), serving as a shift position (see FIG. 1A). When the lever 14 is swung from the N position toward the rear side along the automatic path 16, the lever 14 is disposed at a D position (drive position, forward drive position), serving as a shift position (a predetermined shift position) (see FIG. 1C).

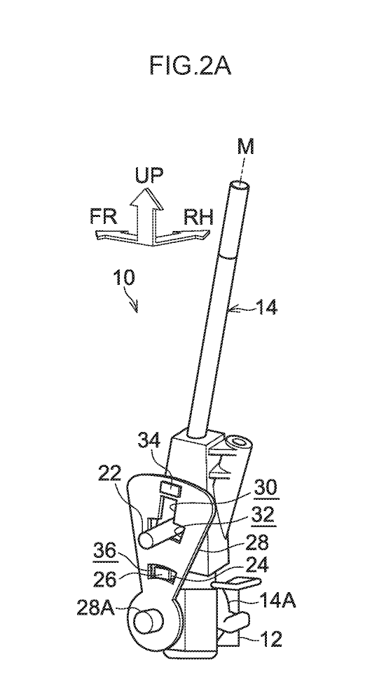

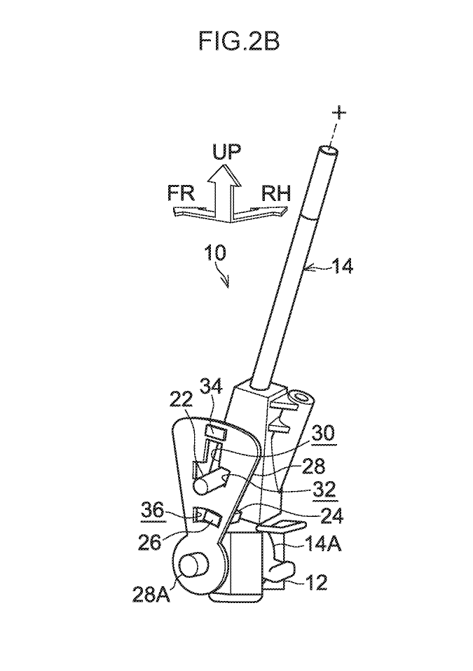

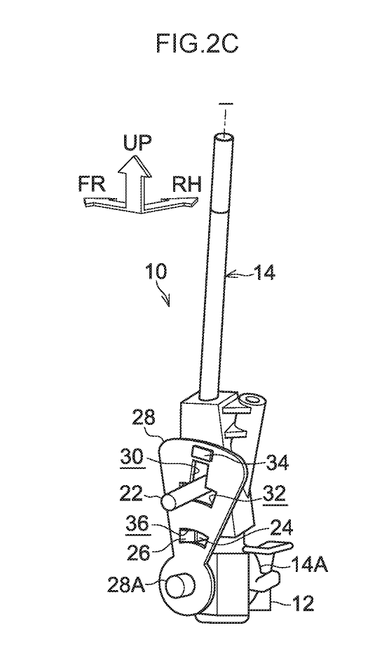

When the lever 14 is swung from the D position toward the left side along the communication path 20, the lever 14 is disposed at an M position (manual position, sequential position), serving as a shift position on the manual path 18 (see FIG. 2A). When the lever 14 is swung from the M position toward the rear side along the manual path 18, the lever 14 is disposed at a + position (plus position, shift up position), serving as a shift position (see FIG. 2B). When the lever 14 is swung from the M position toward the front side along the manual path 18, the lever 14 is disposed at a − position (minus position, shift down position), serving as a shift position (see FIG. 2C).

A circular column shaped coupling column 22, serving as a placement section, is integrally provided to a lower side portion of the lever 14 so as to be located at the upper side of the ball shaft 14A. The coupling column 22 extends toward the left side and is disposed parallel to the left-right direction.

A rectangular column shaped support column 24, serving as a second support section configuring a second movement section of a second detector, is integrally provided at the lower side portion of the lever 14 so as to be located between the ball shaft 14A and the coupling column 22. The support column 24 extends in an upward direction on progression toward the left. A rectangular plate shaped second magnet 26, serving as a second detected section configuring the second movement section of the second detector, is fixed to a leading end face of the support column 24. A left face of the second magnet 26 faces in an upward direction on progression toward the left.

An inverted, substantially triangular plate shaped link 28 (see FIG. 3B), serving as a first support section configuring a first movement section of a first detector, is disposed on the left side of the lever 14. The link 28 is disposed so as to be perpendicular to the left-right direction. A circular column shaped support shaft 28A, serving as a swing axis, is provided at a lower end portion of the link 28. The support shaft 28A is disposed parallel to the left-right direction, and a center axis line of the support shaft 28A passes through the center of the ball shaft 14A of the lever 14. The support shaft 28A is assembled to the lower end of the inside of the first plate configuring the plate. The link 28 is capable of swinging in the front-rear direction about the support shaft 28A.

A torsion spring (torsion coil spring, not illustrated in the drawings), serving as an urging member, is assembled to the support shaft 28A. The support shaft 28A is coaxially inserted into (substantially fitted into) the inside of a helical portion of the torsion spring. One end of the torsion spring is anchored to the front side of the link 28, and the other end of the torsion spring is anchored to the rear side of the link 28. The torsion spring urges the link 28 toward the rear side.

A rectangular shaped coupling hole 30, serving as a movement portion, is formed passing through an upper portion of the link 28. The coupling hole 30 extends along a swing-radial direction (up-down direction) of the link 28. A curved rectangular shaped release hole 32, serving as a maintaining portion, is formed passing through the upper portion of the link 28 so as to be located at the lower side of the coupling hole 30. The release hole 32 extends along a swing-circumferential direction of the link 28, and a central portion (extension direction central portion) of the release hole 32 is in communication with the coupling hole 30.

The coupling column 22 of the lever 14 is inserted through a lower portion of the coupling hole 30. In a state in which the coupling column 22 has been inserted through the coupling hole 30, the coupling column 22 is capable of pushing the link 28 in the front-rear direction, and the coupling column 22 is capable of moving along the coupling hole 30 and the release hole 32.

When the lever 14 is swung from the N position to the R position, the coupling column 22 is swung toward the upper side so as to move from the lower portion to an upper portion of the coupling hole 30, after which the coupling column 22 is swung toward the front side so as to swing the link 28 toward the front side against the urging force of the torsion spring (see FIG. 1A). When the lever 14 is swung from the N position to the D position, the coupling column 22 is swung toward the rear side so as to swing the link 28 toward the rear side in the direction of the urging force of the torsion spring (see FIG. 1C). Thus, when the lever 14 is swung along the automatic path 16, the link 28 is swung along the front-rear direction as a unit with the lever 14.

When the lever 14 is swung from the D position to the M position, the coupling column 22 is swung toward the lower side so as to move from the lower portion of the coupling hole 30 to the central portion of the release hole 32, and the urging force of the torsion spring restricts the link 28 from swinging in the front-rear direction (see FIG. 2A). When the lever 14 is swung from the M position to the + position, the coupling column 22 is swung toward the rear side so as to move from the central portion to a rear portion of the release hole 32 (see FIG. 2B). When the lever 14 is swung from the M position to the − position, the coupling column 22 is swung toward the front side so as to move from the central portion to a front portion of the release hole 32 (see FIG. 2C). Thus, when the lever 14 is swung along the manual path 18, the link 28 is not swung in the front-rear direction as a unit with the lever 14, and the urging force of the torsion spring maintains a front-rear direction swing position of the link 28 in a swing position corresponding to that when the lever 14 is at the D position.

A rectangular plate shaped first magnet 34, serving as a first detected section configuring the first movement section of the first detector, is fixed to a left face of an upper end portion of the link 28 so as to be located at the upper side of the coupling hole 30. A left face of the first magnet 34 faces toward the left side and is disposed so as to be perpendicular to the left-right direction.

A curved rectangular shaped through-hole 36, serving as an exposing section, is formed passing through a lower portion of the link 28 so as to be located between the support shaft 28A and the release hole 32. The through-hole 36 extends along the swing-circumferential direction of the link 28.

The second magnet 26 of the lever 14 is disposed at the upper-right side of the through-hole 36. The second magnet 26 is capable of being inserted into the through-hole 36 (see FIG. 2A to FIG. 2C; the support column 24 of the lever 14 may be configured so as to be capable of passing through the through-hole 36). When the second magnet 26 has been inserted into the through-hole 36, the left face of the second magnet 26 is exposed at the left side of the link 28 in a state facing toward the left and disposed so as to be perpendicular to the left-right direction, and the second magnet 26 is capable of moving so as to follow the through-hole 36.

When the lever 14 is swung from the N position to the R position, the second magnet 26 is swung toward the upper side and then swung toward the front side, such that the second magnet 26 is maintained in a state disposed at the upper-right side of the through-hole 36 (see FIG. 1A). When the lever 14 is swung from the N position to the D position, the second magnet 26 is swung toward the rear side, and the second magnet 26 is maintained in the state disposed at the upper-right side of the through-hole 36 (see FIG. 1C). Thus, the second magnet 26 is not inserted into the through-hole 36 when the lever 14 is swung along the automatic path 16.

When the lever 14 is swung from the D position to the M position, the second magnet 26 is swung toward the lower side and inserted into a central portion (an extension direction central portion) of the through-hole 36 (see FIG. 2A). When the lever 14 is swung from the M position to the + position, the second magnet 26 is swung toward the rear side and moved from the central portion to a rear portion of the through-hole 36 (see FIG. 2B). When the lever 14 is swung from the M position to the − position, the second magnet 26 is swung toward the front side and moved from the central portion to a front portion of the through-hole 36 (see FIG. 2C). Thus, when the lever 14 is swung along the manual path 18, the second magnet 26 is swung in the front-rear direction along the through-hole 36 in a state in which the second magnet 26 is inserted into the through-hole 36.

A substantially flat plate shaped substrate 38, serving as an installation member, is provided on the left side of the link 28. The substrate 38 is assembled to the inside of the first plate of the plate, and is disposed so as to be perpendicular to the left-right direction.

A first sensor 40 (such as a Hall IC), serving as a configuration section of the first detector and a first configuration section (first detection section), is provided on a right face of an upper portion of the substrate 38. A right face of the first sensor 40 is disposed so as to be perpendicular to the left-right direction, and faces the first magnet 34 of the link 28 in the left-right direction. The first sensor 40 detects magnetic force generated by the first magnet 34 to detect a front-rear direction swing position of the first magnet 34. Thus, by detecting the front-rear direction swing position of the link 28, the shift position of the lever 14 is detected to be at the N position, the R position, or the D position when the lever 14 is disposed on the automatic path 16, and the shift position of the lever 14 is detected to be at the D position when the lever 14 is disposed on the manual path 18.

A second sensor 42 (such as a Hall IC), serving as a configuration section of the second detector and a second configuration section (second detection section), is provided at a right face of a lower portion of the substrate 38. A right face of the second sensor 42 is disposed so as to be perpendicular to the left-right direction, and faces the through-hole 36 in the link 28 in the left-right direction. When the second magnet 26 of the lever 14 has been inserted into the through-hole 36, the second sensor 42 detects magnetic force generated by the second magnet 26 to detect a front-rear direction swing position of the second magnet 26. Thus, by detecting the front-rear direction swing position of the lever 14 when the lever 14 is disposed on the manual path 18, the shift position of the lever 14 is detected to be at the M position, the + position, or the − position.

The substrate 38 (the first sensor 40 and the second sensor 42) is electrically connected to a controller (not illustrated in the drawings) of the vehicle. An automatic transmission (transmission, not illustrated in the drawings) of the vehicle is also electrically connected to the controller.

When the first sensor 40 has detected that the shift position of the lever 14 is the N position, under the control of the controller, the shift range of the automatic transmission is changed to an N range (neutral range), and transmission of drive force to the vehicle wheels is disconnected.

When the first sensor 40 has detected that the shift position of the lever 14 is the R position, under the control of the controller, the shift range of the automatic transmission is changed to an R range (reverse range), and reverse drive force is transmitted to the vehicle wheels.

When the first sensor 40 has detected that the shift position of the lever 14 is the D position, under the control of the controller, the shift range of the automatic transmission is changed to a D range (drive range), and forward drive force is transmitted to the vehicle wheels.

In a state in which the first sensor 40 has detected that the shift position of the lever 14 is the D position, when the second sensor 42 has detected that the shift position of the lever 14 is the + position, under the control of the controller, the gear of the automatic transmission is shifted up by one gear.

In the state in which the first sensor 40 has detected that the shift position of the lever 14 is the D position, when the second sensor 42 has detected that the shift position of the lever 14 is the − position, under the control of the controller, the gear of the automatic transmission is shifted down by one gear.

Explanation follows regarding operation of the present exemplary embodiment.

In the shift device 10 with the above configuration, the lever 14 is swung along the automatic path 16 to change the shift position of the lever 14 between the N position, the R position, and the D position. When the lever 14 is swung along the automatic path 16, the coupling column 22 of the lever 14 is inserted into the coupling hole 30 in the link 28. Thus, the link 28 is swung along the front-rear direction as a unit with the lever 14, and the magnetic force generated by the first magnet 34 of the link 28 is detected by the first sensor 40 of the substrate 38 in order to detect the shift position of the lever 14 and change the shift range of the automatic transmission.

Moreover, the lever 14 is swung along the manual path 18 to change the shift position of the lever 14 between the M position, the + position, and the − position. When the lever 14 is swung along the manual path 18, the second magnet 26 of the support column 24 of the lever 14 is inserted into the through-hole 36 in the link 28. Thus, when the lever 14 is swung along the front-rear direction, the magnetic force generated by the second magnet 26 is detected by the second sensor 42 of the substrate 38 in order to detect the shift position of the lever 14 and change the gear of the automatic transmission.

Note that when the lever 14 is swung along the manual path 18, the coupling column 22 of the lever 14 is inserted into the release hole 32 of the link 28, such that the front-rear direction swing position of the link 28 is maintained at a swing position corresponding to that when the lever 14 is at the D position. Thus, the second sensor 42 is able to detect the shift position of the lever 14 on the manual path 18 in a state in which detection by the first sensor 40 that the lever 14 is at the D position is maintained. This enables the shift device 10 to be applied in cases in which the shift position of the lever 14 on the manual path 18 is detected in order to change the gear of the automatic transmission in a state in which detection that the lever 14 is at the D position is maintained.

Furthermore, the torsion spring urges the link 28 toward the swing position corresponding to that when the lever 14 is at the D position from both the front and rear direction sides. This enables the link 28 to be urged toward the swing position corresponding to that when the lever 14 is at the D position from the both front and rear direction sides, and with a simple configuration, enables the front-rear direction swing position of the link 28 to be maintained at the swing position corresponding to that when the lever 14 is at the D position even when the lever 14 is swung along the manual path 18. Moreover, the helical portion of the torsion spring can be disposed coaxially to the support shaft 28A of the link 28, enabling the shift device 10 to be made smaller in size.

Moreover, the first sensor 40 and the second sensor 42 are installed on the same substrate 38. This enables the number of components to be reduced.

Furthermore, the substrate 38 (the first sensor 40 and the second sensor 42) are disposed on the left of (laterally to) the lever 14 and the link 28. This enables liquid (water in particular) to be easily suppressed from reaching and collecting at the substrate 38, enabling the substrate 38 (the first sensor 40 and the second sensor 42) to be easily protected, unlike in cases in which the substrate 38 is disposed below the lever 14 and the link 28.

Moreover, when the lever 14 is swung from the automatic path 16 to the manual path 18, the second magnet 26 of the lever 14 approaches the substrate 38 side (the second sensor 42 side). Furthermore, when the lever 14 is swung along the manual path 18, the second magnet 26 is swung parallel to the substrate 38 (the second sensor 42), and the left face of the second magnet 26 is disposed parallel to the right face of the substrate 38 (the second sensor 42). This enables high quality detection of the shift position of the lever 14 on the manual path 18 by the second sensor 42, enabling the detection accuracy of the shift position of the lever 14 on the manual path 18 to be improved.

Moreover, the coupling hole 30 and the release hole 32 are both provided in the link 28. This enables the number of components to be reduced.

Furthermore, the through-hole 36 in the link 28 exposes the second magnet 26 of the lever 14 at the left side (the opposite side from the lever 14) of the link 28. This enables the first magnet 34 of the link 28 and the second magnet 26 to be disposed closer to each other in the up-down direction (the swing-radial direction of the lever 14 and the link 28) and the front-rear direction (the swing direction of the lever 14 and the link 28), enabling the shift device 10 to be made smaller in size in the up-down direction and front-rear direction, in contrast to in cases in which the through-hole 36 is not provided in the link 28.

Moreover, the ball shaft 14A of the lever 14 and the support shaft 28A of the link 28 are configured as separate bodies. This enables the swing amount of the lever 14 and the swing amount of the link 28 to be made to differ from each other, enabling the front-rear direction swing amount of the lever 14 between shift positions on the automatic path 16, and the front-rear direction swing amount of the first magnet 34 of the link 28, to be easily made to correspond to each other. Moreover, for example, in configurations in which the swing amount of the link 28 is amplified with respect to the swing amount of the lever 14, the swing amount of the first magnet 34 can be amplified with respect to the swing amount of the lever 14, thereby enabling the detection accuracy of the shift position of the lever 14 on the automatic path 16 to be improved.

Furthermore, the support tube 12, the lever 14 (the support column 24 and the second magnet 26), the link 28 (the first magnet 34), the torsion spring, and the substrate 38 (the first sensor 40 and the second sensor 42) are assembled to the first plate configuring the plate. This enables the ease of assembly of the support tube 12, the lever 14 (the support column 24 and the second magnet 26), the link 28 (the first magnet 34), the torsion spring, and the substrate 38 (the first sensor 40 and the second sensor 42) to be improved.

Note that in the present exemplary embodiment, the coupling column 22 is provided to the lever 14, and the coupling hole 30 and the release hole 32 are provided in the link 28. However, configuration may be such that the coupling hole 30 and the release hole 32 are provided in the lever 14, and the coupling column 22 is provided to the link 28.

Furthermore, in the present exemplary embodiment, the ball shaft 14A (swing axis) of the lever 14 and the support shaft 28A (swing axis) of the link 28 are configured by separate bodies. However, configuration may be such that a front-rear direction swing axis of the lever 14 and a swing axis of the link 28 are integral to each other (are the same axis). Such cases enable the accuracy of the swing position of the link 28 (the first magnet 34) accompanying swinging of the lever 14 to be improved, enabling the detection accuracy of the shift position of the lever 14 on the automatic path 16 to be improved.

Moreover, in the present exemplary embodiment, the first magnet 34 and the second magnet 26 are respectively provided to the link 28 and the support column 24, and the first sensor 40 and the second sensor 42 are provided to the substrate 38 (the installation member). However, configuration may be such that the first sensor 40 is provided to the link 28 and the first magnet 34 is provided to the installation member, or such that the second sensor 42 is provided to the support column 24 and the second magnet 26 is provided to the installation member.

Furthermore, in the present exemplary embodiment, the shift position of the lever 14 is changed between the N position, the R position, and the D position on the automatic path 16, and changed between the M position, the + position, and the − position on the manual path 18. However, the shift positions of the lever 14 may be laid out differently or may include other shift positions. For example, the R position of the lever 14 may be disposed in front of the N position of the lever 14. Alternatively, configuration may be such that the lever 14 is disposed at a P position (parking position), such that the shift range of the automatic transmission is changed to a P range (parking range), transmission of drive force to the vehicle wheels is disconnected, and an output shaft of the automatic transmission is locked (a parking lock). In such cases, the P position of the lever 14 may be disposed at the front side of the R position of the lever 14.

Moreover, in the present exemplary embodiment, the shift device 10 is a floor-mounted type, and is installed to the floor section of the vehicle cabin. However, configuration may be such that the shift device 10 is installed to a steering column or an instrument panel of the vehicle.

The disclosure of Japanese Patent Application No. 2016-165752, filed on Aug. 26, 2016, is incorporated in its entirety by reference herein.

### EXPLANATION OF THE REFERENCE NUMERALS

10 shift device
14 lever (shift body)
14A ball shaft (swing axis)
16 automatic path (first movement path)
18 manual path (second movement path)
22 coupling column (placement section)
24 support column (second detector, second movement section)
26 second magnet (second detector, second movement section)
28 link (first detector, first movement section)
28A support shaft (swing axis)
30 coupling hole (movement portion)
32 release hole (maintaining portion)
34 first magnet (first detector, first movement section)
36 through-hole (exposing section)
38 substrate (installation member)
40 first sensor (first detector, configuration section, first configuration section)
42 second sensor (second detector, configuration section, second configuration section)

1. A shift device comprising:
a shift body that is moved along a first movement path and along a second movement path to change a shift position;
a first detector that is provided with a first movement section moved by movement of the shift body along the first movement path, a shift position of the shift body on the first movement path being detected using movement of the first movement section, and a position of the first movement section being maintained at a position corresponding to that when the shift body is at a predetermined shift position on the first movement path when the shift body is moved along the second movement path; and
a second detector that is provided with a second movement section moved by movement of the shift body along the second movement path, a shift position of the shift body on the second movement path being detected using movement of the second movement section.

2. The shift device of claim 1, wherein the first movement section is capable of swinging, and the shift device includes an urging member that urges the first movement section from both swing direction sides toward a swing position corresponding to that when the shift body is at the predetermined shift position.

3. The shift device of claim 1, further comprising:
a first configuration section that configures the first detector;
a second configuration section that configures the second detector; and
an installation member on which the first configuration section and the second configuration section are installed.

4. The shift device of claim 1, further comprising a configuration section that configures at least one of the first detector or the second detector, and that is disposed laterally to the shift body.

5. The shift device of claim 1, further comprising:
a second configuration section that configures the second detector, the second movement section approaching the second configuration section as the shift body moves from the first movement path to the second movement path, and the second movement section moving parallel to the second configuration section as the shift body moves along the second movement path.

6. The shift device of claim 1, further comprising:
a placement section that is provided at one of the shift body or the first movement section;
a movement portion that is provided at another of the shift body or the first movement section, the placement section being disposed in the movement portion when the shift body is disposed on the first movement path, such that the first movement section is moved by movement of the shift body; and
a maintaining portion that is provided at the other of the shift body or the first movement section, the placement section being disposed in the maintaining portion when the shift body is disposed on the second movement path, such that a position of the first movement section is maintained even if the shift body is moved.

7. The shift device of claim 1, further comprising an exposing section that is provided at the first movement section, and that exposes the second movement section on an opposite side of the first movement section from the shift body.

8. The shift device of claim 1, wherein the shift body and the first movement section are capable of swinging on a same axis.

9. The shift device of claim 1, wherein a swing axis of the shift body and a swing axis of the first movement section are configured so as to be different from each other.

10. The shift device of claim 1, further comprising an assembly member to which the shift body, the first detector, and the second detector are assembled.
